(19) United States
(12) Patent Application Publication
(10) Pub. No.: US 2017/0186330 A1
(43) Pub. Date: Jun. 29, 2017

(54) METHOD OF THREE-DIMENSIONAL GRAPHICAL REPRESENTATION OF A LANDING RUNWAY AXIS

(71) Applicant: THALES, Courbevoie (FR)

(72) Inventors: Emmanuel MONVOISIN, Bordeaux (FR); Thierry GANILLE, Merignac (FR); Johanna LUX, Le Haillan (FR); Pierre MARIANI, Saint Medard en Jalles (FR)

(21) Appl. No.: 15/390,436

(22) Filed: Dec. 23, 2016

(30) Foreign Application Priority Data
Dec. 23, 2015 (FR) 1502675

(51) Int. Cl. G08G 5/02; G08G 5/00; B64D 45/00; G06T 17/05

(52) U.S. Cl. CPC G08G 5/025; G06T 17/05; G08G 5/0021; B64D 45/00; G06T 2200/04; G06T 2207/30241

(57) ABSTRACT

The general field of the invention is that of methods of three-dimensional graphical representation of a landing runway on a viewing screen of an onboard viewing system for aircraft, the said graphical representation being displayed in a synthetic view of an exterior landscape. The graphical representation according to the invention comprises a line disposed along the axis of the runway, the said line being a straight stripe inclined by an angle of between one and a few degrees with respect to the horizontal, the said line beginning at the runway threshold.

The field of the invention is that of man-system interfaces for aeronautical applications, and more particularly that of synthetic viewing systems comprising means for displaying a three-dimensional synthetic image of the exterior landscape.

Modern aircraft generally possess a synthetic vision system (SVS). This system makes it possible to present to the crew a synthetic image of the exterior landscape generally comprising information on piloting or navigation.

An SVS system comprises a cartographic database representative of the terrain overflown, a geolocation system, electronic computation means and one or more viewing devices installed in the cockpit of the aircraft. The geolocation system is of the “GPS” type, the acronym standing for “Global Positioning System”. It may be coupled with the inertial system of the craft. As a whole, the geolocation system provides at least the following parameters: position of the aircraft in terms of latitude, longitude and altitude and orientation of the aircraft in terms of pitch, roll and heading.

Generally, the image is displayed on the viewing screens which are situated on the front face of the aircraft's instrument panel. The image is a three-dimensional view of the exterior represented in the most realistic possible manner. The viewpoint displayed is on the axis of the craft.

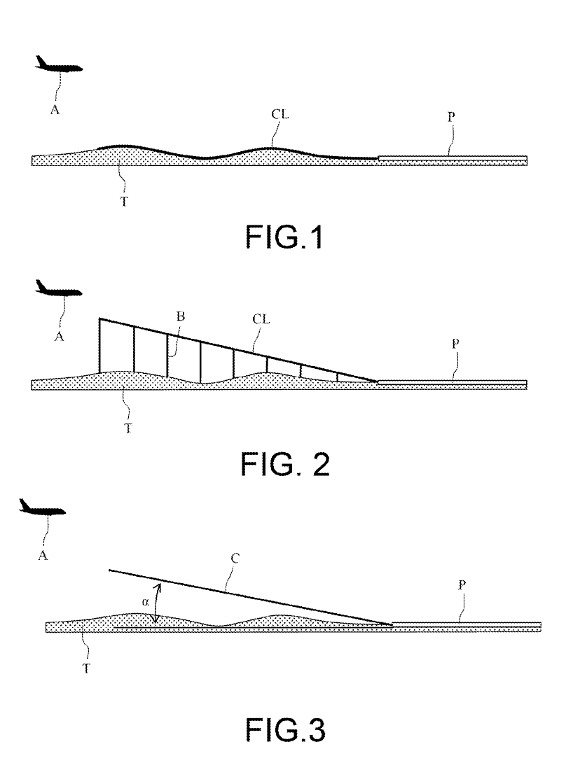

This synthetic image generally comprises symbology for aiding piloting and navigation. In the landing runway approach phase, this symbology comprises information making it possible to aid stabilization on approach and to aid comparison with the descent plan for pilots. This aid takes the form of an extension of the runway axis, also called “extended runway centreline” or “extended centreline” or more simply “centreline”. In the subsequent description, this extended or prolonged axis is referred to as the runway axis or “centreline”. U.S. Pat. No. 7,463,954 entitled “Terrain augmented symbology” describes an extension of the runway axis which hugs the terrain. FIG. 1 illustrates this solution. It represents a vertical sectional plane of a terrain T overflown by an aircraft A. This terrain comprises a landing runway P. The centreline CL is a line represented in bold in this figure.

The drawbacks of this solution are that there may be very annoying visual artefacts such as flicker phenomena, better known by the term “flickering”, due to the overlaying of this line on the terrain. The centreline may also be masked by rugged terrain which lies between the carrier and the centreline. In this case, the latter loses a large part of its interest.

A second solution is described in U.S. Pat. No. 8,099,202 entitled “System and method for providing a final approach curtain”, which describes a “curtain” composed of vertical bands symbolizing the centreline. FIG. 2 illustrates this second solution. It represents a vertical sectional plane of a terrain T overflown by an aircraft A. This terrain comprises a landing runway P. The centreline CL is an incline composed of vertical bands B represented in bold in this figure. The drawback is that this representation takes up a great deal of room and may mask some information through an overload effect, better known by the term “cluttering”.

The method according to the invention does not present these drawbacks. The centreline is a straight segment inclined by a small slope and disposed along the axis of the runway. More precisely, the subject of the invention is a method of three-dimensional graphical representation of a landing zone on a viewing screen of an onboard viewing system for aircraft, the said graphical representation being displayed in a synthetic view of an exterior landscape, characterized in that the said graphical representation comprises a line disposed along the approach axis of the landing zone, the said line being a straight stripe inclined by an angle of between a few tenths of a degree and a few degrees with respect to the horizontal, the said line beginning at the threshold of the landing zone.

Advantageously, the said line is represented by dashes, the distance between two dashes being constant and lying between 0.1 and 10 nautical miles.

Advantageously, the said line comprises several equidistant graduations.

Advantageously, the graduations are of identical shape or of different shape.

Advantageously, the graduations are in the shape of a capital V or a triangle.

Advantageously, the graduations comprise labels.

Advantageously, the line comprises configurable and reconfigurable waypoints and the waypoints comprise labels.

Advantageously, the line has a length of between 1 and 40 nautical miles.

Advantageously, the landing zone is a landing runway for aircraft, the said line being along the axis of the said landing runway.

Advantageously, when the aircraft is a helicopter, the orientation of the landing zone approach axis is chosen by the crew.

The invention will be better understood and other advantages will become apparent on reading the nonlimiting description which follows and by virtue of the appended figures, among which:

FIG. 1 represents a vertical sectional plane of a terrain comprising a landing runway and a first centreline according to the prior art;

FIG. 2 represents a vertical sectional plane of a terrain comprising a landing runway and a second centreline according to the prior art;

FIG. 3 represents a vertical sectional plane of a terrain comprising a landing runway and a centreline according to the invention;

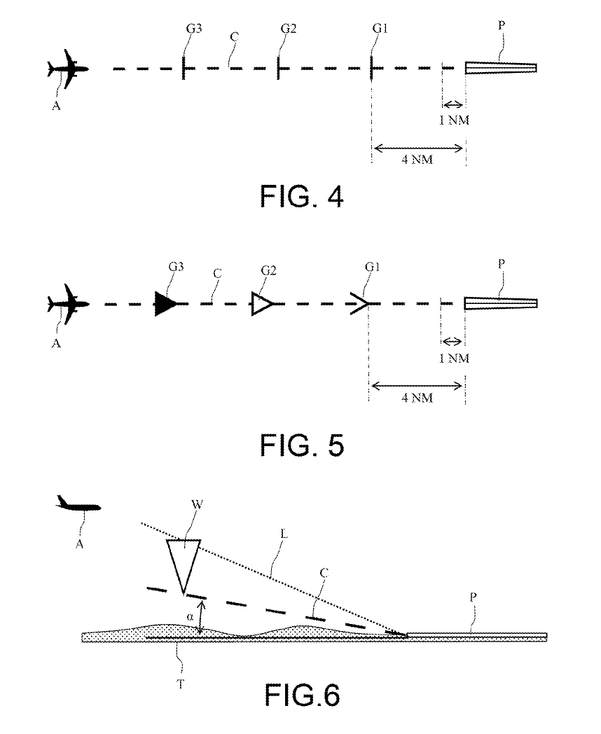

FIG. 4 represents, viewed from above, a first variant of display of a centreline according to the invention;

FIG. 5 represents, viewed from above, a second variant of display of a centreline according to the invention;

FIG. 6 represents, in a vertical sectional plane, a third variant of display of a centreline according to the invention.

The method according to the invention is implemented in a synthetic viewing system or SVS onboard an aircraft. The latter may be a fixed-wing aircraft. In this case, the landing zone is an airport landing runway. The aircraft may also be a helicopter. In this case, the approach axis is not necessarily physically demarcated. It may be defined by the crew or by the avionics system as a function of various parameters such as the wind, the obstacles, etc. In what follows, the example adopted is the case of landing on a landing runway.

The SVS system comprises at least one cartographic database, geolocation means, electronic means making it possible to compute a representation of the main parameters of the aircraft, a graphics computer and at least one viewing device. The geolocation means are, by way of example, of “GPS” type, the acronym standing for “Global Positioning System”, coupled/hybridized or not with inertial platforms.

The display on the screen of the viewing device represents a three-dimensional synthetic view of the terrain overflown. This view may comprise a synthetic representation of a landing runway. In this case, the graphical representation comprises a line disposed along the axis of the runway, the said line being a straight stripe inclined by an angle a of between one and a few degrees with respect to the horizontal, the said line beginning at the runway threshold. FIG. 3 represents this line C in a vertical sectional plane of a terrain T overflown by an aircraft A on the approach to a runway P. This angle is preferentially one degree.

This representation is therefore not overlaid on the terrain and does not give rise to any flickering. This centreline may be masked by the terrain when it intercepts the latter. This has the advantage of giving the pilot an indication regarding the presence of a potentially dangerous relief. These cases are rare since, in general, the approach slope over a runway is of the order of 3 degrees. Thus, the centreline with a 1-degree slope is, in the majority of cases, under the approach axis of the aeroplane and therefore always visible from the aircraft. There is therefore no untimely passage above and below the centreline as may be the case with a centreline having a slope that is equal or close to the approach slope.

Preferably, the centreline is a straight line in a representation based on wireframe and vector plot, and not on texture mapping, so as to avoid the widening effect at the bottom of the display screen, at the level of the “HSI” symbology, the acronym standing for “Horizontal Situation Indicator”.

The centreline may be represented as a stripe a few metres wide. For example, the width may be 4 metres.

Its length may be limited. The line then has a length of between 1 and 40 nautical miles.

The line may be represented unbroken. But, as seen in FIG. 4 which represents a view from above of the centreline, the latter may also be represented by dashes, the distance between two dashes being constant and lying between 0.1 and 10 nautical miles. For example, as represented in FIG. 4, the distance between two dashes may be 1 nautical mile. The by dashes representation is a good compromise between the legibility of the line and that of the terrain situated just below.

It may also comprise equidistant graduations so that the pilot can approximately comprehend the distance separating the carrier from the runway threshold. For example, the distance between two graduations may be 4 nautical miles. There are, for example, three of them. Thus, the line may have three graduations G1, G2 and G3 disposed respectively at 4 nautical miles, 8 nautical miles and 12 nautical miles. Also, in the case where the graduations are not equidistant, the line may have three graduations disposed respectively at 3 nautical miles, 5 nautical miles and 10 nautical miles. These values correspond near enough to the distances of the markers signalling the final approach, called “Inner, Middle and Outer Markers”.

These graduations may all be identical as seen in FIG. 4. It may be advantageous to present them in the form of mutually differing symbols positioned on the centreline at predefined distances, as seen in FIG. 5. This presents the advantage of allowing the pilot to comprehend the distance without needing to display the distance as numerals. Accordingly, a symbol is associated with a distance. Moreover, this allows the pilot to determine the distance even if a single symbol is visible on the screen. Thus, the symbol G1 representing the shortest distance may be a capital V, the symbol G2 representing the average distance the three sides of a triangle and the symbol G3 representing the longest distance a solid triangle. The centreline may also comprise labels indicating the value of each graduation.

The centreline may also comprise other so-called “3D” functionalities to improve visualization and comprehension of the axis and of the approach slope. Thus, as seen in FIG. 6 which represents a vertical sectional view of the terrain overflown, in place of the graduations, the line may comprise waypoints W or “User Waypoints”, positionable by the pilot in terms of distance with respect to the runway threshold, and whose height is computed as a function of the line representing the longitudinal attitude indicator, also called “FPRL”, the acronym standing for “Flight Pitch Reference Line”.

In this case, these waypoints may also comprise labels indicating the distance of the User Waypoints. Advantageously, the User Waypoints are dynamically moveable, for example, by certain control buttons.

1. A method of three-dimensional graphical representation of a landing zone on a viewing screen of an onboard viewing system for aircraft, the said graphical representation being displayed in a synthetic view of an exterior landscape, wherein the said graphical representation comprises a line disposed along the approach axis of the landing zone, the said line being a straight stripe inclined by an angle of between a few tenths of a degree and a few degrees with respect to the horizontal, the said line beginning at the threshold of the landing zone and being situated under the approach axis of the aircraft.

2. The method of graphical representation according to claim 1, wherein the angle of inclination equals about one degree.

3. The method of graphical representation according to claim 1, wherein the said line is represented by dashes, the distance between two dashes being constant and lying between 0.1 and 10 nautical miles.

4. The method of graphical representation according to claim 1, wherein the said line comprises several equidistant graduations.

5. The method of graphical representation according to claim 4, wherein the graduations are of identical shape.

6. The method of graphical representation according to claim 4, wherein the graduations are of different shape.

7. The method of graphical representation according to claim 6, wherein the graduations are in the shape of a capital V or a triangle.

8. The method of graphical representation according to claim 4, wherein the graduations comprise labels.

9. The method of graphical representation according to claim 1, wherein the line comprises configurable and reconfigurable waypoints.

10. The method of graphical representation according to claim 9, wherein the waypoints comprise labels.

11. The method of graphical representation according to claim 1, wherein the line has a length of between 1 and 40 nautical miles.

12. The method of graphical representation according to claim 1, wherein the said landing zone is a landing runway for aircraft, the said line being along the axis of the said landing runway.

13. The method of graphical representation according to claim 1, wherein, when the aircraft is a helicopter, the orientation of the landing zone approach axis is chosen by the crew.
